(19) United States
(12) Patent Application Publication
(10) Pub. No.: US 2017/0306836 A1
(43) Pub. Date: Oct. 26, 2017

(54) ENDLESS DRIVE ARRANGEMENT WITH TENSIONING SYSTEM AND ISOLATION DEVICE

(71) Applicant: LITENS AUTOMOTIVE PARTNERSHIP, Woodbridge (CA)

(72) Inventors: Boris Replete, Toronto (CA); Ron Farewell, Mississauga (CA); Andrew M. Boyes, Aurora (CA)

(21) Appl. No.: 15/520,467

(22) PCT Filed: Oct. 20, 2015
(86) PCT No.: PCT/CA2015/051056

§ 371 Date: Apr. 20, 2017

Related U.S. Application Data
(60) Provisional application No. 62/066,158, filed on Oct. 20, 2014.

(51) Int. Cl. F02B 67/06; F16H 7/12; F16H 7/08

(52) U.S. Cl. CPC F02B 67/06; F16H 7/1281; F16H 7/1218; F16H 2007/0874; F16H 2007/0808

(57) ABSTRACT

In an aspect, a system is provided for controlling tension in an endless drive member, and including an isolation device and a tensioning system. The isolation device is positioned on an accessory drive shaft and has a pulley and a biasing member to transfer force from the pulley to the accessory drive shaft. The isolation device pulley is engaged with the endless drive member, such that a first span of the endless drive member is on a first side of the isolation device pulley and a second span of the endless drive member is on a second side of the isolation device pulley. The tensioning system has a first tensioner pulley engaged with the first span and a second tensioner pulley engaged with the second span. The first and second tensioner pulleys are urged by first and second tensioner pulley biasing forces towards the first and second spans respectively.

### CROSS-REFERENCE TO RELATED APPLICATIONS

This application claims the benefit of U.S. Provisional Patent Application No. 62/066,158 filed Oct. 20, 2014, the contents of which are incorporated herein in their entirety.

### FIELD

This disclosure relates generally to the art of endless drive arrangements and more particularly to systems for vehicular front engine accessory drive arrangements that employ a motor/generator unit or other secondary motive unit in addition to an engine.

### BACKGROUND

Vehicular engines typically employ a front engine accessory drive to transfer power to one or more accessories, such as an alternator, an air conditioner compressor, a water pump and various other accessories. Some vehicles are hybrids and employ both an internal combustion engine, along with an electric drive. There are many possible configurations of such vehicles. For example, in some configurations, the electric motor is used to assist the engine in driving the vehicle (i.e. the electric motor is used to temporarily boost the amount of power being sent to the driven wheels of the vehicle). In some configurations, the electric motor is used to drive the driven wheels of the vehicle by itself and only after the battery is exhausted to a sufficient level does the engine turn on to take over the function of driving the vehicle.

While hybrid vehicles are advantageous in terms of improved fuel economy, their operation can result in higher stresses and different stresses on certain components such as the belt from the front engine accessory drive, which can lead to a reduction in the operating life of these components. It would be advantageous to provide improved operating life for components of the front engine accessory drive in a hybrid vehicle.

### SUMMARY

In an aspect, a system is provided for controlling tension in an endless drive member, including an isolation device and a tensioning system. The isolation device is positioned on a drive shaft of an accessory (also referred to as an accessory drive shaft). The isolation device has an isolation device pulley that is rotatable and an isolation device biasing member that is positioned to transfer force from the isolation device pulley to the drive shaft of the accessory. The isolation device pulley is engaged with the endless drive member, such that a first span of the endless drive member is on a first side of the isolation device pulley and a second span of the endless drive member is on a second side of the isolation device pulley. The tensioning system has a first tensioner pulley engaged with the first span of the endless drive member and a second tensioner pulley engaged with the second span of the endless drive member. The first and second tensioner pulleys are urged by selected first and second tensioner pulley biasing forces towards the first and second spans respectively.

In another aspect, an endless drive arrangement is provided for an engine, including a crankshaft pulley that is drivable by a crankshaft of the engine, an endless drive member that is engaged with the crankshaft pulley, an accessory that is drivable by the endless drive member, an isolation device and a tensioning system. The isolation device has an isolation device pulley that is rotatable and an isolation device biasing member that is positioned to transfer force from the isolation device pulley to the drive shaft of the accessory. The isolation device pulley is engaged with the endless drive member, such that a first span of the endless drive member is on a first side of the isolation device pulley and a second span of the endless drive member is on a second side of the isolation device pulley. The tensioning system has a first tensioner pulley engaged with the first span of the endless drive member and a second tensioner pulley engaged with the second span of the endless drive member. The first and second tensioner pulleys are urged by selected first and second tensioner pulley biasing forces towards the first and second spans respectively.

### BRIEF DESCRIPTION OF THE DRAWINGS

The foregoing and other aspects of the invention will be better appreciated with reference to the attached drawings, wherein:

FIG. 1 is a plan view of an endless drive arrangement on an engine in accordance with an embodiment of the disclosure and including an endless drive member, an isolation device, and a two pulley tensioning system represented only by the two pulleys, showing the endless drive member under several different tension conditions;

FIGS. 2a-2c are plan views of the endless drive arrangement shown in FIG. 1, showing a first embodiment of the tensioning system with the endless drive member in the different tension conditions shown in FIG. 1;

FIG. 3 is a plan view of the endless drive arrangement shown in FIG. 1 including a second embodiment of the tensioning system;

FIG. 4 is a plan view of the endless drive arrangement shown in FIG. 1 including a third embodiment of the tensioning system;

FIG. 5 is a plan view of the endless drive arrangement shown in FIG. 1 including a fourth embodiment of a tensioning system;

FIG. 6 is a plan view of the endless drive arrangement shown in FIG. 1 including a fifth embodiment of a tensioning system;

FIGS. 7a-7d are graphs illustrating the torsional vibration in an MGU pulley under certain conditions for on variously configured endless drive arrangements;

FIG. 7e is a graph that is a combination of the graphs shown in FIGS. 7a-d;

FIG. 8 is a graph illustrating the torque present at an MGU pulley during a key start event for an endless drive arrangement without a tensioning system and without an isolation device, and for an endless drive arrangement with a tensioning system and an isolation device;

FIG. 9 is a sectional view of an alternative embodiment of an isolation device to that shown in FIG. 1;

FIG. 10a is an elevation view of a portion of the isolation device shown in FIG. 9, in a condition during normal operation of a vehicle engine; and

FIG. 10b is an elevation view of a portion of the isolation device shown in FIG. 9, in an overrun condition.

### DETAILED DESCRIPTION OF EXAMPLE EMBODIMENTS

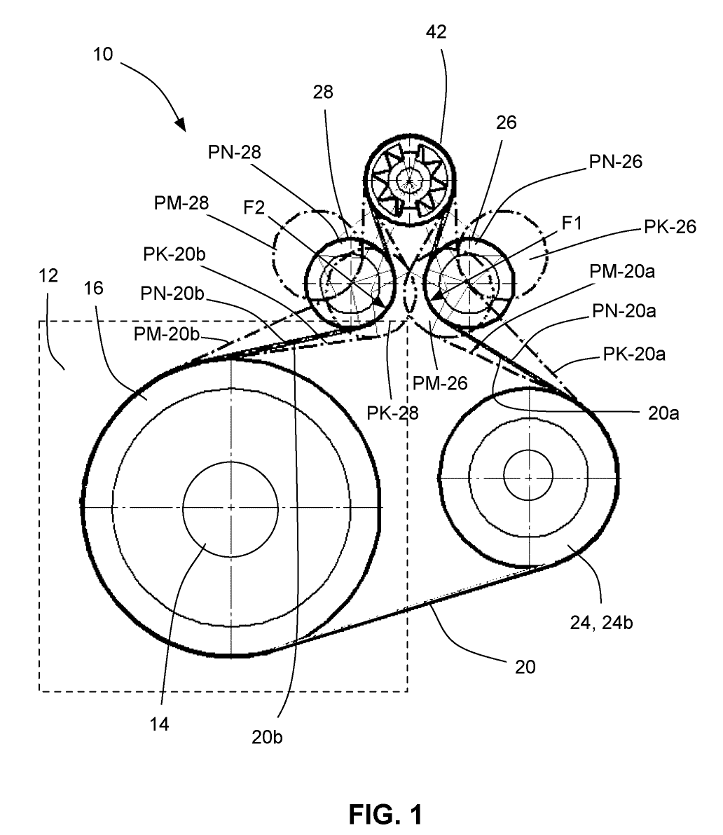

FIG. 1 shows an endless drive arrangement 10 for an engine, schematically represented by a dashed-line rectangle and shown at 12. In embodiments wherein the engine 12 is mounted in a vehicle, the endless drive arrangement 10 may be a front engine accessory drive. The engine 12 includes a crankshaft 14 that has a crankshaft pulley 16 mounted thereon. The crankshaft pulley 16 is drivable by the crankshaft 14 of the engine 12 and itself drives one or more vehicle accessories 18 via an endless drive member 20, such as a belt. For convenience the endless drive member 20 will be referred to as a belt 20, however it will be understood that it could be any other type of endless drive member. The accessories 18 may include a motor-generator unit (MGU) 18a, an air conditioning compressor 18b, a water pump (not shown), a power steering pump (not shown) and/or any other suitable accessory.

In FIG. 1, two accessories 18 are shown, however there could be more or fewer accessories. Each of the driven accessories has a drive shaft 22 and a pulley 24. The MGU 18a has an MGU drive shaft 22a and an MGU pulley 24a.

As can be seen in FIG. 1, the belt 20 is engaged with the crankshaft pulley 16 and the MGU pulley shown at 24a (and the other accessory pulleys 24). Under normal operating conditions, the endless drive arrangement 10 may be driven by the engine 12, and in turn drives the pulleys 24 of the accessories 18. The MGU 18a is operable as an alternator, wherein it is driven by the belt 20 to charge the vehicle's battery (not shown). The MGU 18a is also operable as a motor, wherein it drives the MGU pulley 24a drives the belt 20 via the MGU pulley 24a. This may be during a ‘boost’ event when the engine is driving the wheels of the vehicle, but additional power is desired to supply further power to the wheels indirectly by transferring power to the engine's crankshaft 14 via the belt 20. Another situation in which the MGU 18a is operated as a motor include a BAS (Belt-Alternator Start) event, in which the MGU 18a drives the belt 20 in order to cause rotation of the crankshaft 14, and thereby start the engine 12. Yet another situation in which the MGU 18a is operated as a motor is an ISAF (Idle/Stop Accessory Function) event, when the MGU 18a is used to drive the belt 20 in order to drive one or more accessories when the engine is off (e.g. in some hybrid vehicles where the engine is turned off automatically when the vehicle is at a stoplight or is otherwise stopped briefly).

Another situation that differs from ‘normal’ operation of the engine 12 is a key start event, which is when the engine 12 is started using the vehicle's starter motor (not shown) as is commonly used for non-hybrid vehicles today. In this situation, the MGU 14a is not operated as a motor to drive the belt. Instead, the belt 20 is driven by the crankshaft pulley 16. Typically, the crankshaft pulley 16 (and consequently, the belt 20) receives a large amount of torque during a key start event, higher than is normally applied to the belt 20 by the crankshaft pulley 16 during ‘normal’ operation of the engine 12.

When the endless drive arrangement 10 is operated in a normal mode of operation, tension in a first span 20a of the belt 20 is lower than tension in a second span 20b of the belt 20, due to the driving force exerted on the belt 20 by the crankshaft pulley 16 and the drag forces exerted on the belt 16 by the accessory pulleys 24. By contrast, in any situation where the MGU 18a is used to drive the belt 20 such as during a BAS or ISAF event, tension in the second span 20b of the belt 20 is lower than tension in the first span 20a of the belt 20, due to the driving force exerted on the belt 20 by the MGU pulley 24a and the drag forces exerted on the belt 20 by the accessory pulleys 24. During a key start, the torque applied by the crankshaft pulley 16 to the belt 20 is high as compared to during the normal mode of operation. In the present disclosure, the span 20a of the belt 20 may be referred to at the belt span 20a, and the span 20b of the belt 20 may be referred to as the belt span 20b.

FIG. 1 shows the belt position during each of the three above-noted situations. PN-20a and PN-20b show the positions of the belt spans 20a and 20b respectively, during the normal mode of operation of the engine 12 and the endless drive arrangement 10. PM-20a and PM-20b show the positions of the belt spans 20a and 20b respectively, during events where the MGU 18a is used as a motor to drive the belt 20. PK-20a and PK-20b show the positions of the belt spans 20a and 20b respectively, during a key start (or similar high-crankshaft torque) event when the torque applied to the belt 20 by the crankshaft pulley 16 is relatively high as compared to during normal operation. For the purposes of this disclosure, ‘normal’ operation may be when the vehicle is being driven at some selected speed on a level road at a speed that is generally appropriate for city-driving, where one or more of the accessories, such as the air conditioning compressor 18b, are being driven by the belt 20. Regardless of what specific parameters are used to describe the ‘normal’ operation, it will be understood that the torque applied by the crankshaft pulley 16 to the belt 20 during ‘normal’ operation is less than that applied during a key start event.

It will be noted that the MGU 18a is but one example of a secondary motive device that can be used as a motor to drive the belt 20 for any of the purposes ascribed above to the MGU 18a. In an alternative example, the accessory 18a may be a typical alternator and a separate electric motor may be provided adjacent to the alternator (either upstream or downstream on the belt 20 from the alternator) to driving the belt 20 when it is desired to boost acceleration of the vehicle, in BAS operation, and/or in ISAF operation.

Thus it may be said that the belt 20 is movable between a high crankshaft torque position (shown by PK-20a and PK-20b), and a high secondary device torque position (shown by PM-20a and PM-20b), and is also operable in a ‘normal’ position that is between the high crankshaft torque position and the high secondary device torque position (shown by PN-20a and PN-20b). In some situations it may be equally or more appropriate to refer to the high secondary device torque position as a low crankshaft torque position.

As can be seen in FIG. 1, there is a relatively large amount of movement of the belt 20 during operation of the engine 12 and the endless drive arrangement 10.

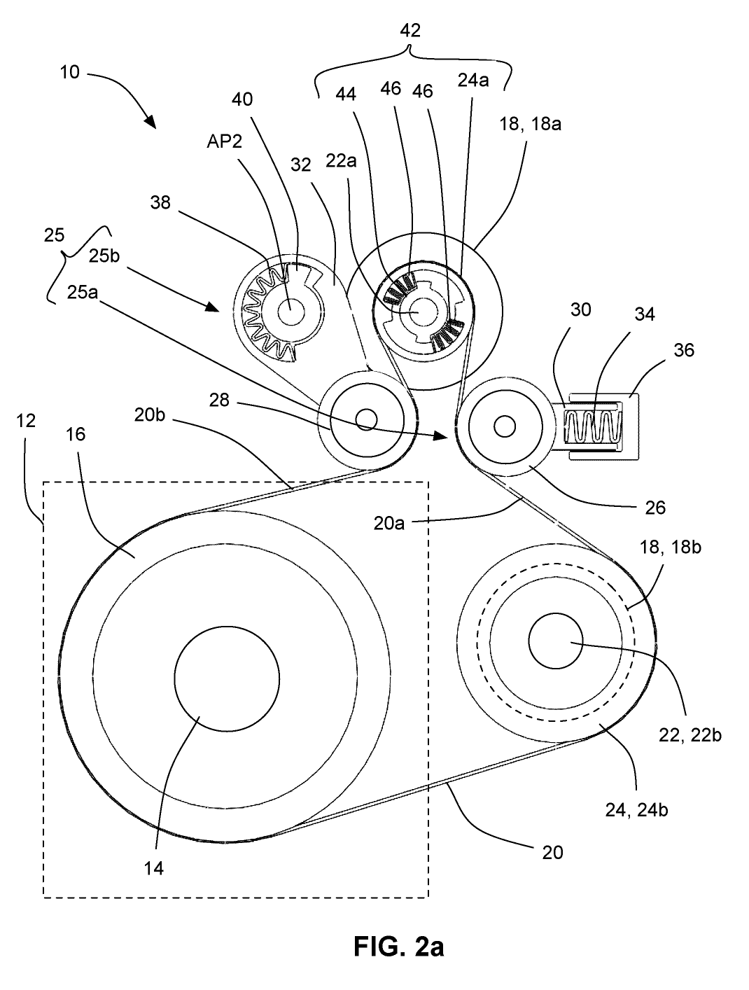

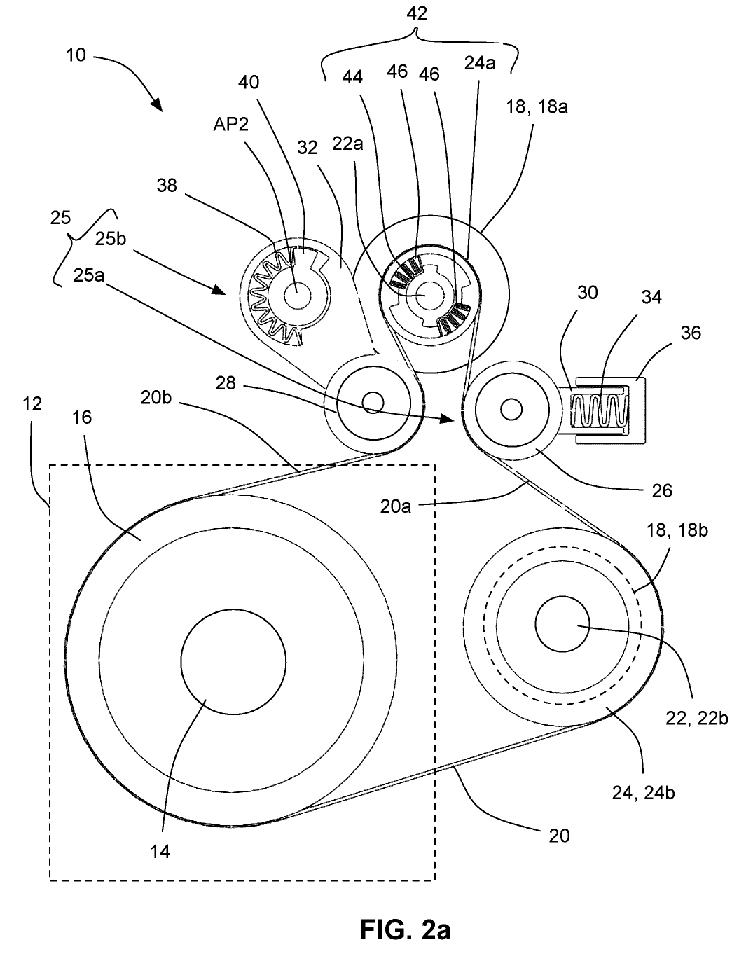

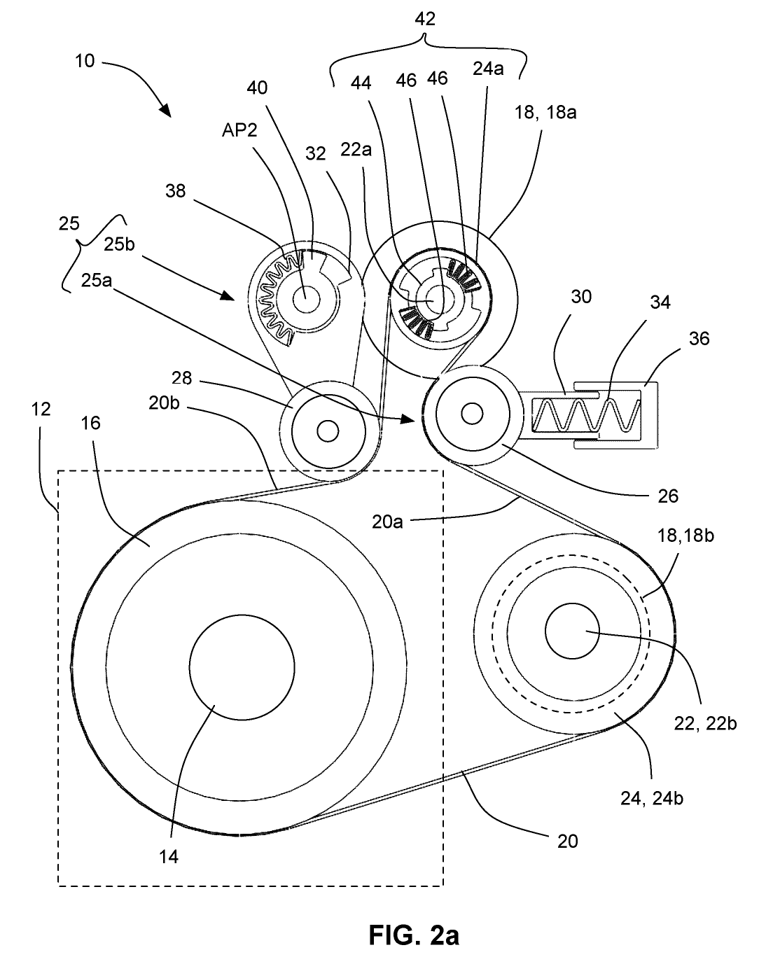

A tensioning system 25 for the endless drive arrangement 10 is shown in FIGS. 2a-2c. FIG. 2a corresponds to the belt position shown at PN-20a and PN-20b in FIG. 1. FIG. 2b corresponds to the belt position shown at PK-20a and PK-20b in FIG. 1. FIG. 2c corresponds to the belt position shown at PM-20a and PM-20b in FIG. 1.

The tensioner system 25 includes a first tensioner pulley 26 that is engaged with the first span 20a and a second tensioner pulley 28 that is engaged with the second belt span 20b. The first tensioner pulley 26 is rotatably mounted on a first tensioner arm 30 and is movable between a first position (shown in broken lines at PK-26 in FIG. 1) which corresponds to the high crankshaft torque position for the belt 20, and a second position (shown in broken lines at PM-26 in FIG. 1) which corresponds to the high secondary device torque position for the belt 20. An example position of the first tensioner pulley 26 at an example crankshaft torque during normal operation of the engine 12 and endless drive arrangement 10 is shown at PN-26 in FIG. 1.

The second tensioner pulley 28 is rotatably mounted on a second tensioner arm 32 (FIGS. 2a-2c) and is movable between a first position (shown in broken lines at PK-28 in FIG. 1) which corresponds to the high crankshaft torque position for the belt 20, and a second position (shown in broken lines at PM-28 in FIG. 1) which corresponds to the high secondary device torque position for the belt 20. An example position of the second tensioner pulley 28 at the aforementioned example crankshaft torque during normal operation of the engine 12 and endless drive arrangement 10 is shown at PN-28 in FIG. 1.

The first and second tensioner pulleys 26 and 28 are urged by selected first and second tensioner pulley biasing forces F1 and F2 towards the first and second belt spans 20a and 20b respectively. These tensioner pulley biasing forces F1 and F2 may be generated by any suitable structure. For example, the force F1 may be generated by a first tensioner pulley biasing member 34 (FIGS. 2a-2c), which may be, for example, a linear helical compression spring that extends between the first tensioner arm 30 and a first tensioner base 36 that is fixedly mounted to the engine 12 (via a bracket that is not shown but which would be readily understood by one skilled in the art). The first tensioner arm 30 may be slidably mounted to the first tensioner base 36 for telescopic movement relative to the first tensioner base 36.

The force F2 may be generated by a second tensioner pulley biasing member 38, which may be, for example, an arcuate helical compression spring that extends between the second tensioner arm 32 and a second tensioner base 40 that is fixedly mounted to the block of the engine 12 (via a bracket that is not shown but which would be readily understood by one skilled in the art). The second tensioner arm 32 may be pivotally mounted to the second tensioner base 40 for pivoting movement about a second arm pivot axis AP2.

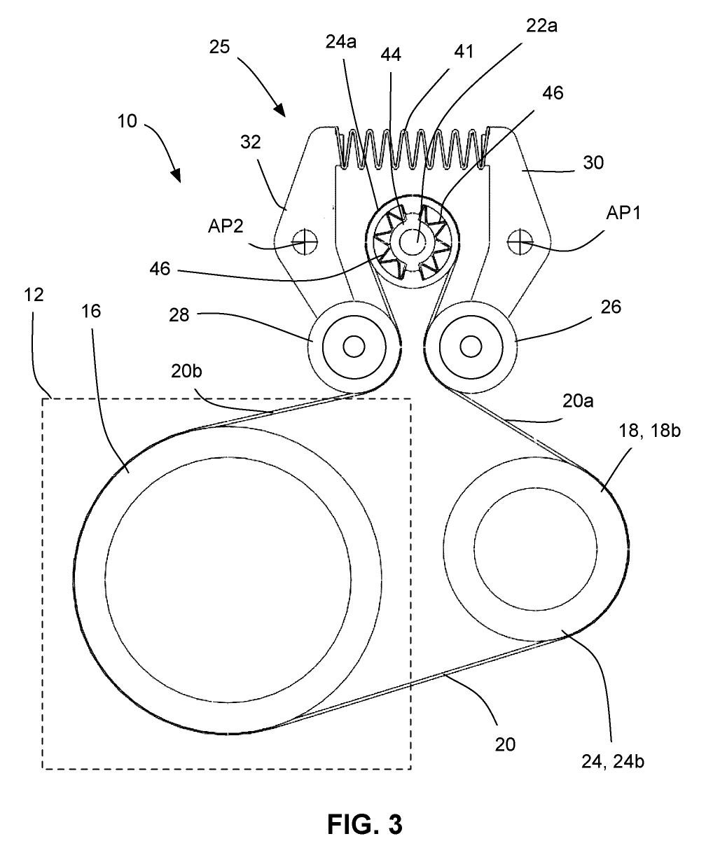

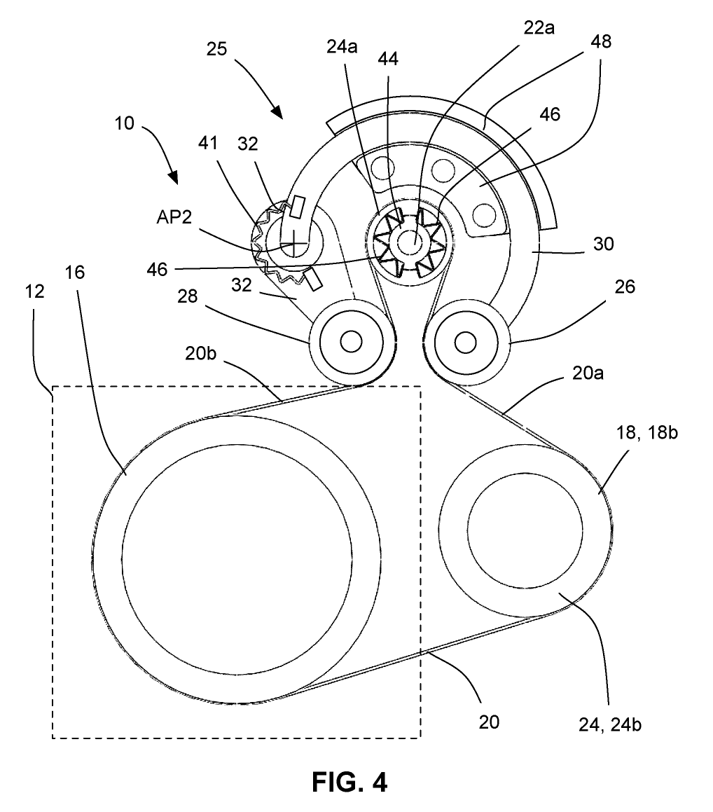

It can be seen that the forces F1 and F2 in the example shown in FIG. 1 are generated by separate biasing members, namely springs 34 and 38, which are on separate tensioner assemblies shown at 25a and 25b that together make up the tensioning system 25. However, while the springs 34 and 38 (and the tensioning assemblies 25a and 25b) are separate from one another, their spring properties (e.g. their respective spring rates) may be selected together based on selected operating characteristics of the endless drive arrangement, such as the amount of tension that the belt 20 will incur during operation. Furthermore, in other embodiments, shown in FIGS. 3-6 the forces F1 and F2 are provided via a single spring. For example, in FIG. 3, the first and second tensioner arms 30 and 32 are both pivotally connected to a base (not shown) which is itself fixedly mounted to the housing of the MGU 18a, and are pivotable about respective first and second arm pivot axes AP1 and AP2. A single helical compression spring 41 extends between the first tensioner arm 30 and the second tensioner arm 32 and urges the first and second arms 30 and 32 in respective directions to drive the pulleys 26 and 28 into the first and second belt spans 20a and 20b respectively, with the forces F1 and F2 respectively. In the embodiment shown in FIG. 4 a base 48 that mounts fixedly to the housing of the MGU 18a is shown. The first arm 30 slides orbitally on the base 48 a common axis with the axis of rotation of the MGU shaft 22a. The second arm 32 is pivotally mounted to the first arm 30. An arcuate helical compression spring 41 exerts forces on the two arms 30 and 32 which result in the first and second forces F1 and F2 on the pulleys 26 and 28 to drive the pulleys 26 and 28 into the first and second belt spans 20a and 20b respectively. Several examples of such a tensioning system are shown in PCT publication WO2014100894A1, the contents of which are incorporated herein by reference in their entirety.

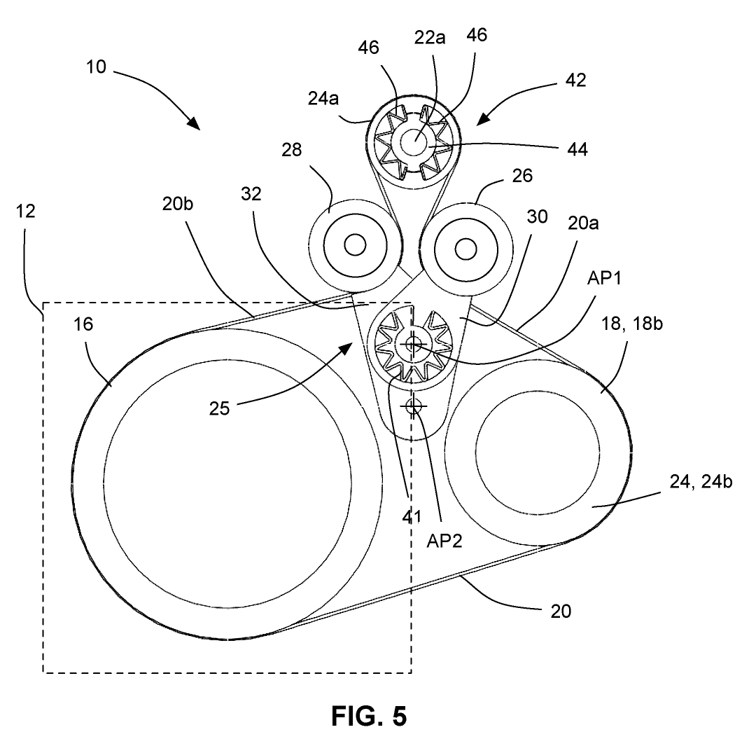

In the embodiment shown in FIG. 5, a Y-tensioner is shown in which the first arm 30 is pivotally mounted to the second arm 32 for pivotal movement about first arm pivot axis AP1, and the second arm 32 is pivotally mounted to the block of the engine 12 for pivotal movement about second arm pivot axis AP2, wherein an arcuate, helical compression spring that is the tensioner spring 41 extends between the two arms 30 and 32 and exerts forces on the two arms 30 and 32 which result in the first and second forces F1 and F2 on the pulleys 26 and 28 to drive the pulleys 26 and 28 into the first and second belt spans 20a and 20b respectively. Examples of such a tensioning system are shown and described in US20130260932A1, the contents of which are incorporated herein by reference in their entirety.

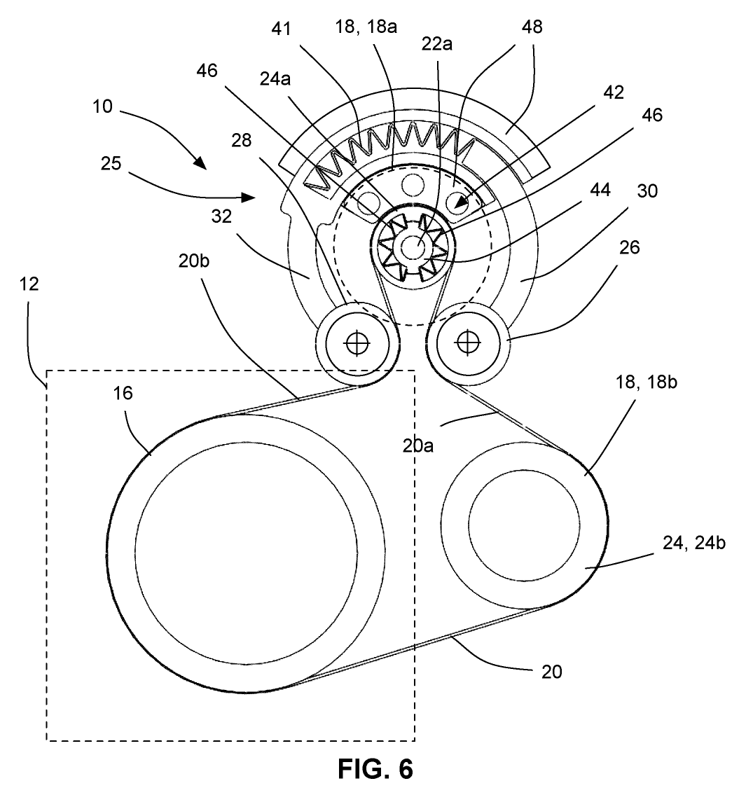

In the embodiment shown in FIG. 6, the tensioning system 25 employs a base 48 that is mounted to a stationary element such as the housing of the MGU 18a (shown in dashed outline in FIG. 6). The tensioning system 25 further includes a first tensioning arm 30 and a second arm 32 that are both arcuate and that telescope from one another. A single tensioner pulley biasing member 41 which in the embodiment shown is an arcuate, helical compression spring, exerts forces on the two arms 30 and 32 so as to apply the forces F1 and F2 on the first and second pulleys 26 and 28 to drive the pulleys 26 and 28 into the belt spans 20a and 20b respectively.

The MGU pulley 24a may not be solidly connected to the MGU shaft 22a, and may instead be part of an isolation device 42 that is configured to transmit power between the belt 20 and MGU shaft 22a. In the embodiment shown, the isolation device 42 includes the aforementioned MGU pulley 24a that is engageable with the belt 20, a hub 44 that is mountable to the MGU shaft 22a, and at least one isolation spring 46 that is configured to transmit power between the MGU pulley 24a and the hub 44. Because the MGU pulley 24a also forms part of the isolation device, it may be referred to as the isolation device pulley 24a.

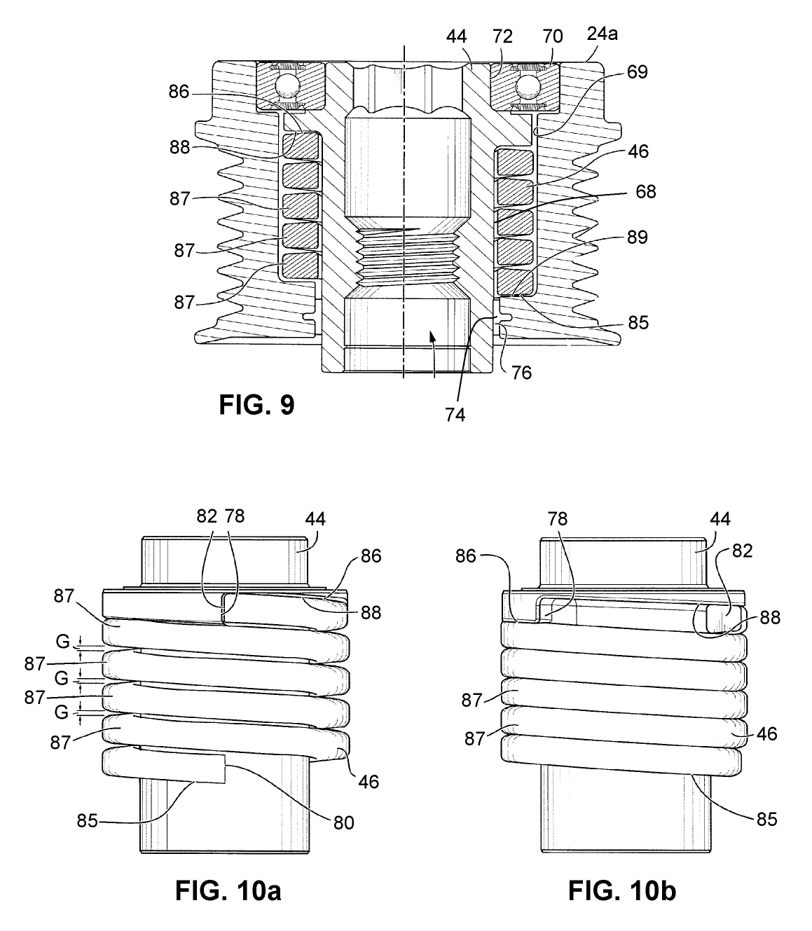

Examples of suitable isolation devices that could be used for the isolation device 42 are shown in PCT publication WO2012061930A1, the contents of which are incorporated herein by reference in their entirety. The isolation device 42 may include some amount of overrunning capability. For example, in the embodiment shown in FIGS. 9, 10a and 10b, the isolation device 42 includes a single torsional isolation spring 46 that extends around the hub 44 in a chamber between an outer surface 68 of the hub 44 and an inner surface 69 of the MGU pulley 24a. A bearing 70 is provided on a bearing support surface 72 at one end of the hub 44 between the pulley 24a and the hub 44, and a bushing 74 is provided on a bushing support surface 76.

The isolation spring 46 acts between a pulley drive surface (not shown) on the pulley 24a and a hub drive surface 78 on the hub 44 (FIGS. 10a and 10b). A first helical end 80 of the isolation spring 46 abuts the pulley drive surface, and a second helical end 82 of the isolation spring 46 abuts the hub drive surface 78.

The isolation spring 46 has a first axial end 85 and a second axial end 86 and a plurality of coils 87 between the first and second axial ends, which are separated from adjacent coils by a gap G (FIG. 10a). The second axial end 86 is shown in abutment with a helical ramp 88 on the hub 44. Optionally the first axial end 85 alternatively or additionally engages a similar helical ramp 89 on the pulley 24a.

During normal operation of the engine 12 (FIG. 1), the torque on the pulley 24a is higher than that on the hub 44 and as a result, the pulley 24a drives rotation of the hub 44 via the isolation spring 46, as shown in FIG. 10a.

During moments when the torque on the pulley 24a is lower than on the hub 44 the hub 44 is driven to overrun the pulley 24a, which is shown in FIG. 10b. For example, during engine shutdown no positive torque is applied to the pulley 24a or the hub 44. However, the amount of frictional resistance to movement of the other components engaged with the belt 20 is higher than the amount of frictional resistance to movement of the hub 44. Thus it may be said in during engine shutdown that a lower torque is present on the pulley 24a than on the hub 44 (e.g. a large frictional torque on the pulley 24a as compared to a small frictional torque on the hub 44). As a result, momentum in the rotor of the MGU 24a drives the hub 44 to overrun the pulley 24a. In another example, during events when the MGU 18a is being operated as a motor to drive the pulley 24a and consequently, the belt 20, the torque on the hub 44 is greater than the torque on the pulley 24a.

The structure of the isolation device 42 shown in FIGS. 9, 10a and 10b permits some amount of overrun by permitting the spring 46 the drive surfaces (78, and not shown, respectively) to pull away from the helical ends 82 and 80, respectively). It can be seen during such movement, the ramps 88 and 89 rotate relative to one another. The relative movement the rotation of the ramps 88 and 90 relative to one another drives axial compression of the spring 46. The gaps G between the coils 87 of the spring 46 permit some axial compression of the spring 46 to occur during the aforementioned riding up one or both ramps 88 and 89. Without the gaps G between the coils, lock up of the spring 46 would prevent relative rotation of the ramps 88 and 89 (and therefore of the hub 44 and the pulley 24a) occur since no axial compression would be possible. The size of the gaps G impacts the amount of overrun that is available.

In an alternative embodiment, overrunning capability may be provided by way of a clutch that can be selectively operated in two different modes, including a first mode where it operates as a one-way clutch (thereby providing overrunning capability), and in a second mode where it remained fixed in an engaged condition so that there is no disengagement and thus no overrunning capability. Examples of such an isolation device are shown in WO2015070329A1, the contents of which are incorporated herein by reference in their entirety. Providing an isolation device 42 that can operate in the aforementioned second mode permits the isolation device 42 to transfer torque from the MGU shaft 22a to the belt 20 during events where the MGU 18a is being operated as a motor.

The spring properties that are selected for the isolation springs 46 are selected based on the torsional vibration characteristics of the endless drive arrangement 10 and based on the spring properties selected for the spring 41 or the springs 34 and 38 that drive the tensioner pulleys 26 and 28 into the belt 20.

When the engine 12 is in operation, torsional vibrations will be transmitted from the crankshaft 14 into the belt 20, which are the result of inertia in the belt 20 and the driven accessories 18, and the reciprocating movement of the engine's pistons. The torsional vibrations are passed to the MGU pulley 24a via the belt 20. The isolation device 42 reduces the amplitude of these vibrations such that the amplitude of torsional vibration in the MGU shaft 22a is significantly lower than it is at the MGU pulley 24a. However, some vibration is transmitted, which has an amplitude associated with it. This amplitude directly impacts the longevity of the isolation device 42.

Separately, operation of the engine 12 entails at least one key start event per session, and a number of BAS start events, a number of boost events and a number of ISAF events. Each of these events results in a certain profile of torque transmission to the belt 20, which directly impacts the position and movement of the tensioning system 25. Over many years, there can be tens of thousands of key start events, hundreds of thousands of BAS start events and millions of boost events. The severity of these events directly impacts the stresses incurred by the tensioning system 25 and therefore the operating life of the tensioning system 25.

It has been found, surprisingly, that the presence of the isolation device 42 and the presence of the tensioning system 25 have a significant positive effect on each other. More specifically, the presence of the tensioning system 25 has been found to (significantly, in some instances) reduce the amplitude of torsional vibration that exists at the MGU pulley 24a and at the MGU shaft 22a, thereby improving the performance of the isolation device 42 the isolation device 42 and improving the performance of the isolation device 42. At the same time, the presence of the isolation device 42 has been found to (significantly, in at least some instances) reduce the peak torque that is present in the belt 20 and that is transmitted in one form or another to the tensioner 25 during a key start event or any of the events that occur where the MGU 18a is operated as a motor. FIG. 8 shows a torque curve 50 that represents the torque that is present at an MGU pulley during a key start event on a hypothetical belt drive arrangement where there is no tensioning system and no isolation device. FIG. 8 further shows a torque curve 52 that represents the torque that is present at an MGU pulley during a key start event on an endless drive arrangement that includes a tensioning system 25 and an isolation device 42. As can be seen, the peak torque for the curve 50 is significantly higher than the peak torque for the curve 52.

By reducing the peak torque that is exerted to drive the belt 20 during these events, the belt tension, and consequently the amount of movement that occurs in the arms 30 and 32 before equilibrium is reached, is reduced. The reduced amount of movement and the reduced forces present in the tensioning system components during such movement directly impact the operating life of the tensioning system 25 positively. Additionally, the lower belt tension means that the peak stresses during events such as key starts are reduced for many components associated with the endless drive arrangement 10, such as the belt 20 itself and the bearings that support the various pulleys such as the MGU pulley 24a and the air conditioning pulley 24b. Accordingly, the operating life of all these components can increase by a reduction in the peak stresses that occur during events such as a key start. This discovery is surprising, at least because the same benefits are not known to be significantly true for typical belt drive systems in non-hybrid vehicles, which incorporate a single pulley tensioner, and a decoupler on the alternator shaft.

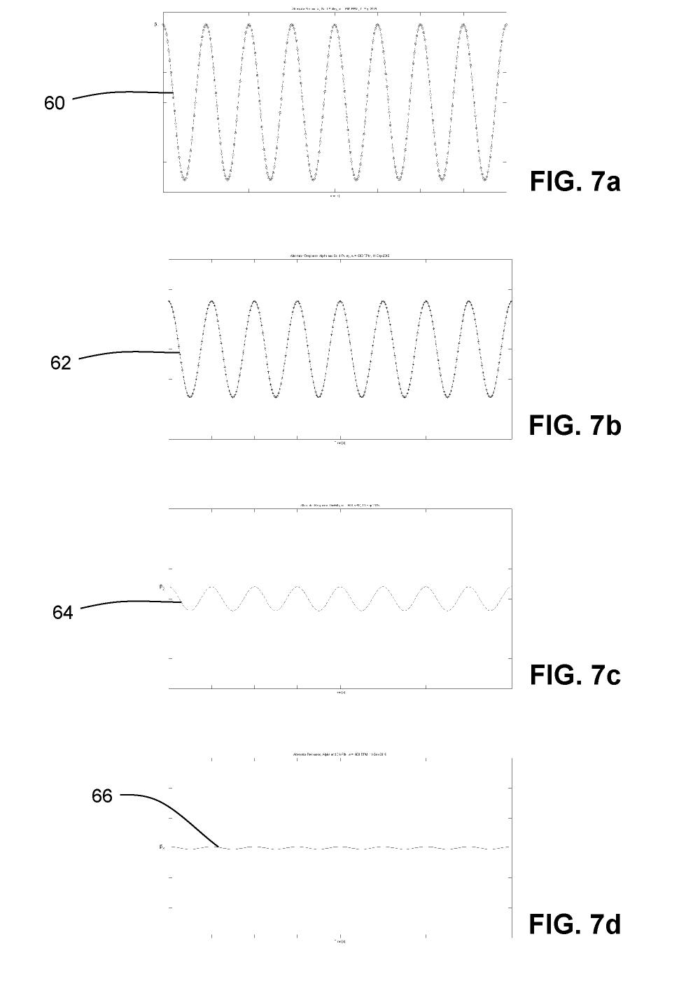

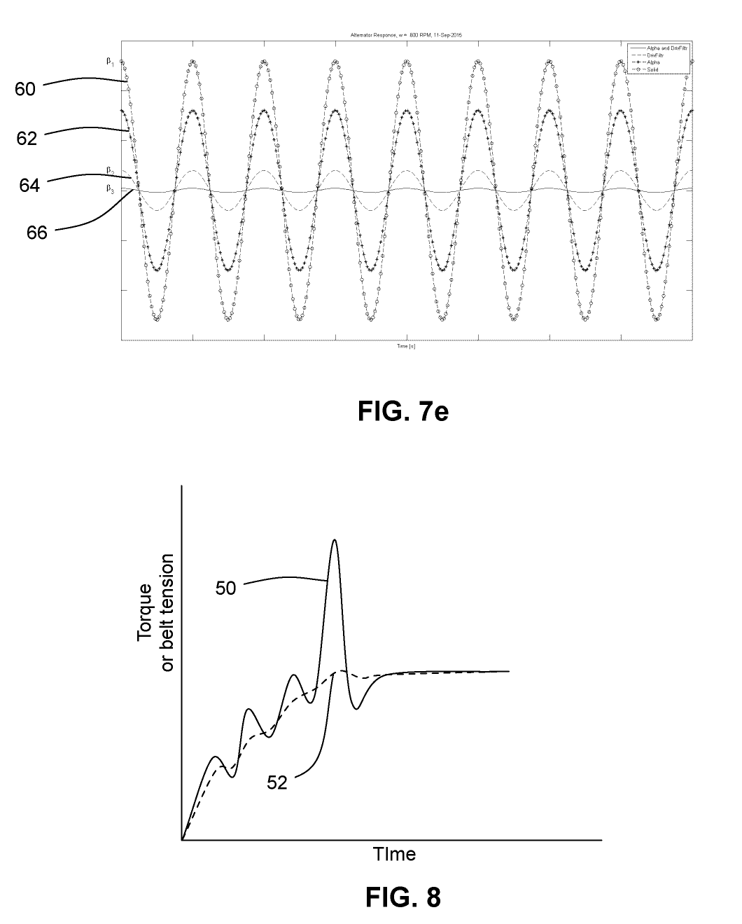

FIGS. 7a-7e are graphs that illustrate the amplitude of torsional vibration incurred by the isolation device 42 in different embodiments. The curve shown at 60 in FIG. 7a shows the amplitude of torsional vibration that would exist in a hypothetical situation, if the pulleys and 26, 28, 24a were rotatable about fixed axes (i.e. with no tensioning system present) and if no isolation device was present. The curve shown at 62 in FIG. 7b shows the amplitude of torsional vibration that would exist under the same operating conditions as are represented in FIG. 7a, but with a tensioning system 25 present, and with no isolation device on the MGU 18a. As can be seen, the amplitude of the torsional vibrations is lower than the amplitude of torsional vibration shown in FIG. 7a but is still relatively high. The curve shown at 64 in FIG. 7c shows the amplitude of torsional vibration that would exist under the same operating conditions as are represented in FIG. 7a, but with no tensioning system present, and with an isolation device 42 on the MGU 18a. As can be seen, the amplitude of the torsional vibrations is significantly lower than the amplitude of torsional vibration shown in FIG. 7b. The curve shown at 66 in FIG. 7d shows the amplitude of torsional vibration that would exist under the same operating conditions as are represented in FIG. 7a, but with a tensioning system 25 present, and with an isolation device 42 on the MGU 18a. As can be seen, the amplitude of the torsional vibrations is significantly lower than the amplitude of torsional vibration that exists when the isolation device 42 is provided without the tensioning system 25 as shown in FIG. 7c. Thus, the performance of the isolation device 42 is increased as compared to the use of the isolation device 42 without the two-armed tensioning system 25. FIG. 7e shows the curves 60, 62, 64 and 66 all superimposed on one another to facilitate comparison of their respective amplitudes.

It is theorized that the following analysis applies to the analysis with respect to the curves shown in FIGS. 7a-7e. If a hypothetical endless drive arrangement were provided in which the pulleys 26 and 28 were not movable and there is no isolation device 42, (i.e. the situation represented by the curve 60 in FIG. 7a), the following analysis would be applicable. The crankshaft pulley 16 undergoes a certain amount of torsional vibration, which has an amplitude represented by A (in angular units such as degrees for example). The amplitude of the corresponding torsional vibration at the MGU pulley 24a can be represented by B1, which is equal to A×r(C/S)/r(MGU), where r(MGU) is the radius of the MGU pulley 24a and r(C/S) is the radius of the crankshaft pulley 16. B1 is the amplitude represented by the curve 60 shown in FIG. 7a. Elastic stretching of the belt 20 itself may contribute to some isolation of any torsional vibrations, however for most typical belts 20 such elastic stretching would be very small and therefore negligible for the purposes of the present description.

If an isolation device 42 is included in the aforementioned hypothetical endless drive arrangement then a reduction in the amplitude results, which can be represented by a value S, which depends on parameters such as the moment of inertia of the MGU rotor and the spring stiffness (or more generally, the spring properties) of the isolation springs 46. Therefore the amplitude of the torsional vibration at the MGU pulley 24a can be represented by B2, which is equal to A×r(C/S)/r(MGU)−S. This amplitude is represented as curve 64 in FIG. 7c.

If a two-pulley tensioning system 25 is further included in the aforementioned hypothetical endless drive arrangement then a further reduction in the amplitude results, which results in the curve 66 in FIG. 7d. More specifically, the length of the belt span 20b during torsional vibrations changes as the belt tightens and slackens (i.e. as the tension in the belt span 20b fluctuates). For example, as can be seen in FIG. 1, the length of the belt span 20b is greater at the lower tension position PK-20b than it is at the higher tension position PM-20b. When the length of the belt span 20b decreases by some amount due to a tension change in the belt span 20b, the length of the belt span 20a increases by essentially the same amount, assuming all other factors are substantially unchanged and assuming the overall length of the belt is substantially constant. The change in length of each belt span 20a and 20b is represented by DL. The change in length of each belt span 20a and 20b (i.e. the amount of belt that is effectively transferred from one span 20a or 20b to the other) has a direct effect on the resultant amplitude of the torsional vibration at the MGU pulley 24a, for a given amplitude of vibration at the crankshaft pulley 16. The effect (expressed as an angular change in the amplitude of the vibration at the MGU pulley 24a) is characterized mathematically by:

T=arctan(DL/r(MGU)).

The amplitude of the torsional vibration at the MGU pulley 24a can be represented by B3, which is equal to A×r(C/S)/r(MGU)−S—arctan(DL/r(MGU)).

The endless drive arrangement 10 has been shown in the figures for use with an MGU 18. However, in some embodiments, a two-pulley tensioning system 25 and an isolation device 42 could be used to advantage in an endless drive arrangement that employs an alternator and that has no secondary motive device. In such embodiments, the isolation device 42 may include no overrunning capability, or may include some overrunning capability by way, for example, of a one-way clutch.

The isolation device 42 and the tensioning system 25 may together be considered to be included in a system for controlling tension in a belt or other endless drive member.

While the description contained herein constitutes a plurality of embodiments of the present invention, it will be appreciated that the present invention is susceptible to further modification and change without departing from the fair meaning of the accompanying claims.

1. A system for controlling tension in an endless drive member, comprising:
an isolation device positioned on a drive shaft of an accessory, wherein the isolation device has an isolation device pulley that is rotatable and an isolation device biasing member that is positioned to transfer force from the isolation device pulley to the drive shaft of the accessory, wherein the isolation device pulley is engaged with the endless drive member, such that a first span of the endless drive member is on a first side of the isolation device pulley and a second span of the endless drive member is on a second side of the isolation device pulley; and
a tensioning system having a first tensioner pulley engaged with the first span of the endless drive member and a second tensioner pulley engaged with the second span of the endless drive member, wherein the first and second tensioner pulleys are urged by selected first and second tensioner pulley biasing forces towards the first and second spans respectively.

2. A system as claimed in claim 1, wherein the first and second tensioner pulleys are positioned rotatably on first and second tensioner arms respectively, wherein the first and second tensioner arms are individually movable.

3. A system as claimed in claim 1, wherein the first and second tensioner pulley biasing forces are applied by first and second tensioner biasing members respectively.

4. A system as claimed in claim 2, further comprising a tensioner biasing member that engages the first and second tensioner arms and which applies the first and second tensioning pulley biasing forces to the first and second tensioner pulleys via the first and second tensioner arms.

5. A system as claimed in claim 1, wherein the accessory is an alternator.

6. A system as claimed in claim 1, wherein the accessory is a secondary motive device that is operable to drive the drive shaft of the accessory, such that the isolation device is configured to transfer torque from the secondary motive device to the endless drive member

7. A system as claimed in claim 1, wherein the isolation device hub overruns the isolation device pulley when torque is lower on the isolation device pulley than on the hub.

8. An endless drive arrangement for an engine, comprising:
a crankshaft pulley that is drivable by a crankshaft of the engine;
an endless drive member that is engaged with the crankshaft pulley;
an accessory;
an isolation device positioned on a drive shaft of the accessory, wherein the isolation device has an isolation device pulley that is rotatable and an isolation device biasing member that is positioned to transfer force between the isolation device pulley and the drive shaft of the accessory, wherein the isolation device pulley is engaged with the endless drive member, such that a first span of the endless drive member is on a first side of the isolation device pulley and a second span of the endless drive member is on a second side of the isolation device pulley; and
a tensioning system having a first tensioner pulley engaged with the first span of the endless drive member and a second tensioner pulley engaged with the second span of the endless drive member, wherein the first and second tensioner pulleys are urged by selected first and second tensioner pulley biasing forces towards the first and second spans respectively.

9. An endless drive arrangement as claimed in claim 8, wherein the accessory is a secondary motive device that is operable to drive the drive shaft of the accessory, such that the isolation device is configured to transfer torque from the secondary motive device to the endless drive member.

10. An endless drive arrangement as claimed in claim 9, wherein the first and second tensioner pulleys are positioned rotatably on first and second tensioner arms respectively, wherein the first and second tensioner arms are individually movable.

11. An endless drive arrangement as claimed in claim 9, wherein the first and second tensioner pulley biasing forces are applied by first and second tensioner biasing members respectively.

12. An endless drive arrangement as claimed in claim 11, further comprising a tensioner biasing member that engages the first and second tensioner arms and which applies the first and second tensioning pulley biasing forces to the first and second tensioner pulleys via the first and second tensioner arms.

13. An endless drive arrangement as claimed in claim 8, wherein the accessory is an alternator.

14. An endless drive arrangement as claimed in claim 9, wherein the isolation device hub overruns the isolation device pulley when torque is lower on the isolation device pulley than on the hub.
